(19) United States
(12) Patent Application Publication
(10) Pub. No.: US 2026/0348368 A1
(43) Pub. Date: Nov. 5, 2026

(54) ELECTRICALLY-DRIVEN FRACTURING APPARATUS

(71) Applicant: YANTAI JEREH PETROLEUM EQUIPMENT & TECHNOLOGIES CO., LTD., Yantai, Shandong (CN)

(72) Inventors: Sheng CHANG, Yantai, Shandong (CN); Shouzhe LI, Yantai, Shandong (CN); Liang LV, Yantai, Shandong (CN); Chunqiang LAN, Yantai, Shandong (CN); Kaishen LIU, Yantai, Shandong (CN); Shanwu FU, Yantai, Shandong (CN)

(21) Appl. No.: 19/486,523

(22) PCT Filed: Sep. 5, 2023
(86) PCT No.: PCT/CN2023/116973

§ 371 Date: Nov. 21, 2025

(30) Foreign Application Priority Data
May 24, 2023 (CN) 202321294968.0

(51) Int. Cl. F04B 17/03; E21B 43/26; F04B 53/08; F04B 53/18

(52) U.S. Cl. CPC F04B 17/03; E21B 43/2607; F04B 53/08; F04B 53/18

(57) ABSTRACT

An electrically-driven fracturing apparatus is disclosed. The electrically-driven fracturing apparatus includes a plunger pump, a lubrication system, and a power module. The lubrication system includes a fluid end lubrication system and a power end lubrication system. The fluid end lubrication system is configured to lubricate a fluid end of the plunger pump. The power end lubrication system is configured to lubricate a power end of the plunger pump. The power module is configured to provide power to the plunger pump. The power module includes a power train unit and at least two power units. Output ends of the at least two power units are coupled to an input end of the power train unit. An output end of the power train unit is coupled to the plunger pump.

### TECHNICAL FIELD

The present disclosure relates to the technical field of fracturing apparatuses, and in particular, to an electrically-driven fracturing apparatus.

### BACKGROUND

In view of the fact that global oil and gas development stimulation equipment is developing toward the direction of low energy consumption, low noise, and low emissions, a conventional fracturing apparatus with a diesel engine as a power source is gradually replaced by an electrically-driven fracturing apparatus due to shortcomings such as a large volume, a heavy weight, environmental unfriendliness, and economic inefficiency.

An existing electrically-driven fracturing apparatus basically adopts a motor to drive a plunger pump through a transmission component such as a transmission shaft or coupling. Specifically, one motor is used to drive one plunger pump, or one motor is used to drive two plunger pumps. The motor controls a change in a rotational speed through a frequency converter to realize a change in a rotational speed of the plunger pump, to ultimately achieve a change in displacement of the electrically-driven fracturing apparatus. With this technical solution, the plunger pump of the electrically-driven fracturing apparatus has relatively high power, and the required output power of a single motor is also relatively high, resulting in an extremely large volume and weight of the motor, as well as relatively high difficulty in processing and manufacturing.

### SUMMARY

The present disclosure provides an electrically-driven fracturing apparatus, including:
a plunger pump;
a lubrication system, including a fluid end lubrication system and a power end lubrication system, where the fluid end lubrication system is configured to lubricate a fluid end of the plunger pump, and the power end lubrication system is configured to lubricate a power end of the plunger pump; and
a power module, configured to provide power to the plunger pump, where the power module includes a power train unit and at least two power units, output ends of the at least two power units are coupled to an input end of the power train unit, and an output end of the power train unit is coupled to the plunger pump.

In a possible implementation, the power train unit further includes a main power train unit and an auxiliary power train unit that are coupled together, at least two auxiliary power train units are provided, the auxiliary power train units are coupled to the power units in a one-to-one correspondence, an input end of the main power train unit is coupled to output ends of the auxiliary power train units, and an output end of the main power train unit is coupled to the plunger pump.

In a possible implementation, the power train unit is provided as a one-piece structure, or the power units and the auxiliary power train units are provided as a one-piece structure, or an auxiliary power train unit and a power unit coupled to the auxiliary power train unit are provided as a one-piece structure, or any set of auxiliary power train units and power units that are coupled together are provided as a one-piece structure.

In a possible implementation, any quantity of auxiliary power train units and any quantity of power units that are coupled together are provided as a one-piece structure to form a sub-power module, an output end of the sub-power module is formed by coupling together the auxiliary power train units in the sub-power module, and the output end of the sub-power module is coupled to the input end of the main power train unit.

In a possible implementation, the power train unit further includes a main power train unit and an auxiliary power train unit that are coupled together, the at least two power units are coupled to an input end of the auxiliary power train unit, and an output end of the auxiliary power train unit is coupled to the main power train unit.

In a possible implementation, the power units and the power train units are provided as a one-piece structure, or the power units and the power train units are provided as separate structures.

In a possible implementation, a cooling system is further included. The cooling system is configured to cool the power module.

In a possible implementation, the cooling system includes a cooling medium and a power drive unit, a cooling channel for circulation of the cooling medium is formed in each of the power units and the power train unit, the power drive unit is configured to drive the cooling medium to circulate, and the cooling channels are in contact with outside air to perform heat exchange on the cooling medium through the outside air.

In a possible implementation, the cooling system further includes a cooler in communication with the cooling channels, and the cooler is configured to perform heat exchange on the cooling medium.

In a possible implementation, the cooling system further includes a temperature control module, and the temperature control module is configured to monitor a temperature of the cooling medium, to selectively bring the cooling channels into communication with the cooler.

The technical solutions provided in some embodiments of the present disclosure have the following advantages.

In the electrically-driven fracturing apparatus, the fluid end of the plunger pump is lubricated through the fluid end lubrication system, and the power end of the plunger pump is lubricated through the power end lubrication system. The power module includes at least two power units. A power source is provided to the plunger pump through the at least two power units. In a case that power of the plunger pump remains unchanged, a larger quantity of power units are provided, so that output power of a single power unit may be reduced, thereby reducing a volume and a weight of the single power unit to facilitate processing and manufacturing of the power unit. In addition, a relatively low input speed of the plunger pump results in a relatively low output speed of the power unit. The use of low-speed power unit leads to relatively low efficiency, and the technical solutions provided in some implementations of the present disclosure can reduce the output power of the single power unit and ensure the efficiency of the power unit. In addition, the power train unit is coupled to the power unit, and a rotational speed of the power unit is adjusted through the power train unit, thereby realizing a change in a rotational speed of the plunger pump and ultimately achieving a change in displacement of the electrically-driven fracturing apparatus. The power train unit can increase the rotational speed of the power unit, and the use of a high-speed power unit results in relatively high efficiency.

### BRIEF DESCRIPTION OF THE DRAWINGS

The accompanying drawings herein are incorporated into the specification and constitute a part of the specification, illustrate embodiments that conform to the present disclosure, and are used together with the specification to explain the principles of the present disclosure.

To more clearly describe technical solutions in the embodiments of the present disclosure or in the prior art, the accompanying drawings required for describing the embodiments or the prior art are briefly described below. Apparently, a person of ordinary skill in the art may still derive other accompanying drawings from these accompanying drawings without any creative effort.

One or more embodiments are exemplarily described with reference to pictures in accompanying drawings corresponding to the embodiments, and the exemplary descriptions do not constitute a limitation on the embodiments. Elements in the accompanying drawings that have same reference numerals are represented as similar elements, and unless otherwise particularly stated, the figures in the accompanying drawings do not constitute a scale limitation.

FIG. 1 is a schematic structural diagram of an electrically-driven fracturing apparatus according to an embodiment of the present disclosure.

FIG. 2 is a schematic diagram of an axis side of an electrically-driven fracturing apparatus according to an embodiment of the present disclosure.

FIG. 3 is a principle diagram of an electrically-driven fracturing apparatus according to an embodiment of the present disclosure.

FIG. 4 is a schematic structural diagram of a power module in an electrically-driven fracturing apparatus according to an embodiment of the present disclosure.

FIG. 5 is a schematic diagram of an axis side of a power module in an electrically-driven fracturing apparatus according to an embodiment of the present disclosure.

FIG. 6 is a principle diagram of coupling of a power module in an electrically-driven fracturing apparatus according to an embodiment of the present disclosure.

FIG. 7 is a principle diagram (I) of a power module in an electrically-driven fracturing apparatus according to an embodiment of the present disclosure.

FIG. 8 is a principle diagram (II) of a power module in an electrically-driven fracturing apparatus according to an embodiment of the present disclosure.

FIG. 9 is a principle diagram (III) of a power module in an electrically-driven fracturing apparatus according to an embodiment of the present disclosure.

FIG. 10 is a principle diagram (IV) of a power module in an electrically-driven fracturing apparatus according to an embodiment of the present disclosure.

FIG. 11 is a principle diagram (V) of a power module in an electrically-driven fracturing apparatus according to an embodiment of the present disclosure.

FIG. 12 is a principle diagram (VI) of a power module in an electrically-driven fracturing apparatus according to an embodiment of the present disclosure.

FIG. 13 is a principle diagram (VII) of a power module in an electrically-driven fracturing apparatus according to an embodiment of the present disclosure.

FIG. 14 is a principle diagram (VIII) of a power module in an electrically-driven fracturing apparatus according to an embodiment of the present disclosure.

FIG. 15 is a principle diagram (IX) of a power module in an electrically-driven fracturing apparatus according to an embodiment of the present disclosure.

FIG. 16 is a principle diagram (I) of a cooling system in an electrically-driven fracturing apparatus according to an embodiment of the present disclosure.

FIG. 17 is a principle diagram (II) of a cooling system in an electrically-driven fracturing apparatus according to an embodiment of the present disclosure.

FIG. 18 is a principle diagram (III) of a cooling system in an electrically-driven fracturing apparatus according to an embodiment of the present disclosure.

FIG. 19 is a principle diagram (IV) of a cooling system in an electrically-driven fracturing apparatus according to an embodiment of the present disclosure.

FIG. 20 is a principle diagram (V) of a cooling system in an electrically-driven fracturing apparatus according to an embodiment of the present disclosure.

FIG. 21 is a principle diagram (VI) of a cooling system in an electrically-driven fracturing apparatus according to an embodiment of the present disclosure.

FIG. 22 is a principle diagram (VII) of a cooling system in an electrically-driven fracturing apparatus according to an embodiment of the present disclosure.

FIG. 23 is a principle diagram (VIII) of a cooling system in an electrically-driven fracturing apparatus according to an embodiment of the present disclosure.

FIG. 24 is a principle diagram (IX) of a cooling system in an electrically-driven fracturing apparatus according to an embodiment of the present disclosure.

FIG. 25 is a principle diagram (X) of a cooling system in an electrically-driven fracturing apparatus according to an embodiment of the present disclosure.

FIG. 26 is a principle diagram (XI) of a cooling system in an electrically-driven fracturing apparatus according to an embodiment of the present disclosure.

FIG. 27 is a principle diagram (XII) of a cooling system in an electrically-driven fracturing apparatus according to an embodiment of the present disclosure.

FIG. 28 is a principle diagram (I) of an air-cooling system in an electrically-driven fracturing apparatus according to an embodiment of the present disclosure.

FIG. 29 is a principle diagram (II) of an air-cooling system in an electrically-driven fracturing apparatus according to an embodiment of the present disclosure.

FIG. 30 is a principle diagram (III) of an air-cooling system in an electrically-driven fracturing apparatus according to an embodiment of the present disclosure.

FIG. 31 is a principle diagram (IV) of an air-cooling system in an electrically-driven fracturing apparatus according to an embodiment of the present disclosure.

FIG. 32 is a principle diagram (V) of an air-cooling system in an electrically-driven fracturing apparatus according to an embodiment of the present disclosure.

FIG. 33 is a principle diagram (VI) of an air-cooling system in an electrically-driven fracturing apparatus according to an embodiment of the present disclosure.

### DESCRIPTIONS OF REFERENCE NUMERALS

1. Plunger pump; 2. Power end lubrication system; 3. Fluid end lubrication system; 4. High-pressure manifold assembly; 5. Low-pressure manifold assembly; 6. Power module; 61. Power unit; 62. Power train unit; 7. Cooling system; 71. Power drive unit; 72. Cooler; 73. Temperature control module; 74. Fan.

### DETAILED DESCRIPTION

To make the objectives, technical solutions, and advantages of the present disclosure clearer, the technical solutions in embodiments of the present disclosure are to be described clearly and completely with reference to the accompanying drawings in the embodiments of the present disclosure. Apparently, the described embodiments are some rather than all of the embodiments of the present disclosure. All other embodiments obtained by a person of ordinary skill in the art based on the embodiments in the present disclosure without creative efforts shall fall within the protection scope of the present disclosure.

The following disclosure provides many different embodiments or examples for implementing different structures of the present disclosure. To simplify the disclosure of the present disclosure, components and settings of specific examples are described below. Certainly, they are merely examples and are not intended to limit the present disclosure. In addition, the present disclosure may reuse reference numerals and/or letters in different examples. This reuse is for simplicity and clarity, and does not indicate a relationship between the embodiments and/or arrangements discussed.

For ease of description, terms for spatial relative relationships may be used herein to describe the relative positional relationship or motion of an element or a feature relative to another element or feature as shown in the figures. For example, these relative relationship terms include “interior”, “exterior”, “inside”, “outside”, “under”, “below”, “over”, “above”, “front”, and “back”. Such terms for spatial relative relationships are intended to include different orientations of a device during use or operation other than those shown in the figures. For example, if a device in the figure undergoes a position reversal or a posture change or a motion state change, these indications of directionality also change accordingly. For example, an element described as “under another element or feature” or “below another element or feature” is to be subsequently oriented as “over another element or feature” or “above another element or feature”. Therefore, the example term “below” may include orientations both above and below. The device may be otherwise oriented (rotated by 90 degrees or in another direction), and the spatial relative relationship descriptors used herein are used for explanation accordingly.

To resolve the technical problem in the prior art that an electrically-driven fracturing apparatus adopts one motor to drive one plunger pump or one motor to drive two plunger pumps, resulting in relatively high required output power of a single motor, an extremely large volume and weight of the motor, and relatively high difficulty in processing and manufacturing, the present disclosure provides an electrically-driven fracturing apparatus, which can reduce the power of a single motor and lead to a relatively small volume and weight of the motor and relatively low difficulty in processing and manufacturing.

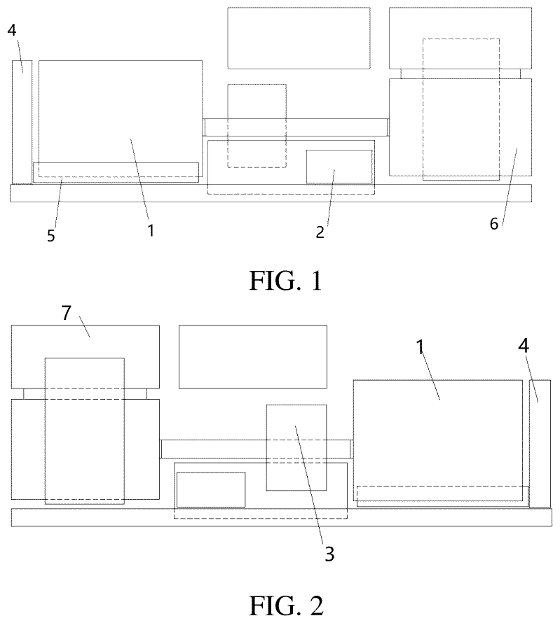

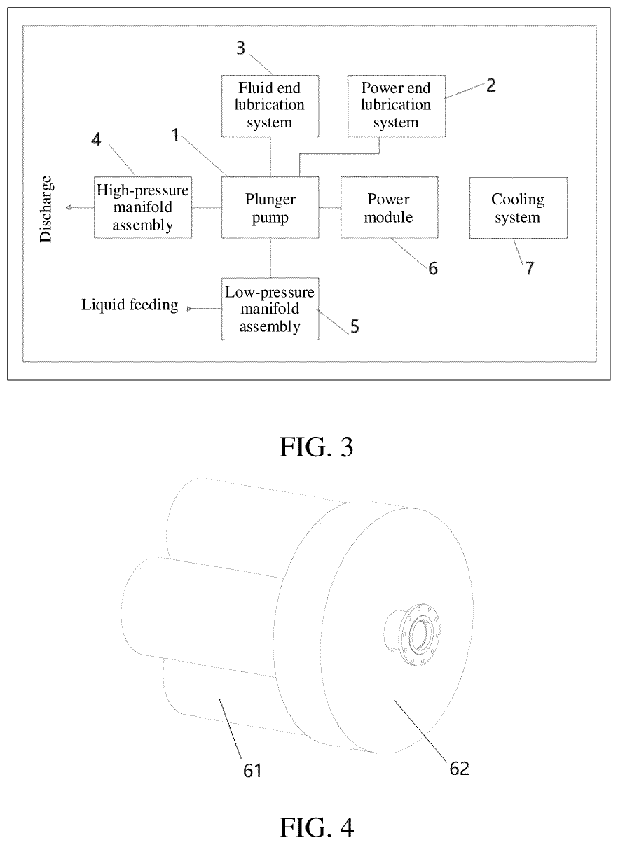

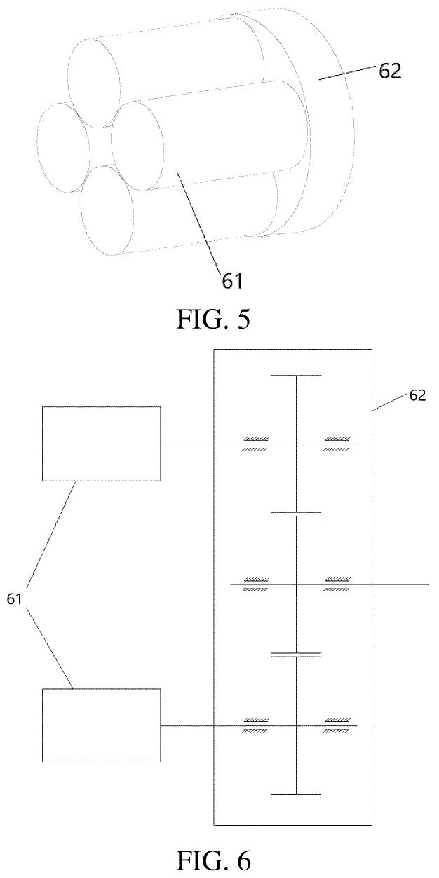

Referring to FIG. 1 to FIG. 7, an embodiment of the present disclosure provides an electrically-driven fracturing apparatus, including:
a plunger pump 1;
a lubrication system, including a fluid end lubrication system 3 and a power end lubrication system 2, where the fluid end lubrication system 3 is configured to lubricate a fluid end of the plunger pump 1, and the power end lubrication system 2 is configured to lubricate a power end of the plunger pump 1; and
a power module 6, configured to provide power to the plunger pump 1, where the power module 6 includes a power train unit 62 and at least two power units 61, output ends of the at least two power units 61 are coupled to an input end of the power train unit 62, and an output end of the power train unit 62 is coupled to the plunger pump 1.

The fluid end of the plunger pump 1 is lubricated through the fluid end lubrication system 3, and the power end of the plunger pump 1 is lubricated through the power end lubrication system 2. The power module 6 includes the at least two power units 61. A power source is provided to the plunger pump 1 through the at least two power units 61. In a case that power of the plunger pump 1 remains unchanged, a larger quantity of power units 61 are arranged, so that output power of a single power unit 61 may be reduced, thereby reducing a volume and a weight of the single power unit 61 to facilitate processing and manufacturing of the power unit 61. In addition, a relatively low input speed of the plunger pump 1 results in a relatively low output speed of the power unit 61. The use of low-speed power unit 61 leads to relatively low efficiency, and the technical solutions provided in the present disclosure can reduce the output power of the single power unit 61 and ensure the efficiency of the power unit 61. In addition, the power train unit 62 is coupled to the power unit 61, and a rotational speed of the power unit 61 is adjusted through the power train unit 62, thereby realizing a change in a rotational speed of the plunger pump 1 and ultimately achieving a change in displacement of the electrically-driven fracturing apparatus. The power train unit 62 can increase the rotational speed of the power unit 61, and the use of a high-speed power unit 61 results in relatively high efficiency.

With reference to FIG. 6, exemplarily, in the present disclosure, a motor is used as the power unit 61. The motor is used as a power source to realize operation of the plunger pump 1.

The motor is coupled to the plunger pump 1 through a transmission component to implement normal operation of the electrically-driven fracturing apparatus. The transmission component includes a transmission shaft, a coupling, or the like. The motor controls a change in a rotational speed through the power train unit 62. Certainly, in practical use, the power unit 61 may also use another structure that can drive the plunger pump 1 to operate. Details are not described herein in the embodiments. The power train unit 62 includes a transmission or a reducer. In the present disclosure, the transmission is used as the power train unit 62. An output end of the motor is coupled to an input end of the transmission through splines, gears, flat keys, flanges, or the like to drive the transmission to operate. The transmission has a speed reduction function, which can reduce a high rotational speed inputted by the motor through a gear structure inside the transmission and then output the reduced rotational speed to the plunger pump 1, to satisfy a relatively low rotational speed requirement for the input of the plunger pump 1. In addition, the transmission increases relatively low torque outputted by the motor and then outputs the increased torque to the plunger pump 1, to satisfy a relatively high input torque requirement of the plunger pump 1. In this way, an output end of the transmission may be coupled to an input end of the plunger pump 1 through splines, flanges, flat keys, or the like. Therefore, when at least two motors are arranged, output ends of a plurality of motors are coupled to the input end of the transmission, and the output end of the transmission is coupled to the input end of the plunger pump 1.

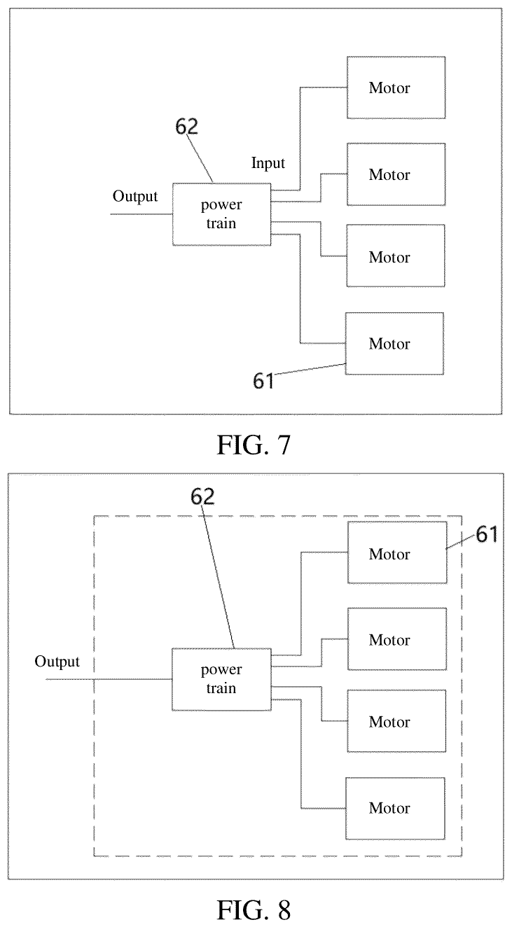

Referring to FIG. 7 and FIG. 8, the power units 61 and the power train unit 62 are provided as a one-piece structure, or the power units 61 and the power train unit 62 are provided as separate structures. To be specific, a plurality of power units 61 and the power train unit 62 are provided as a one-piece structure, or each of the power units 61 and a transmission are both separate components, and are coupled as a whole through subsequent coupling.

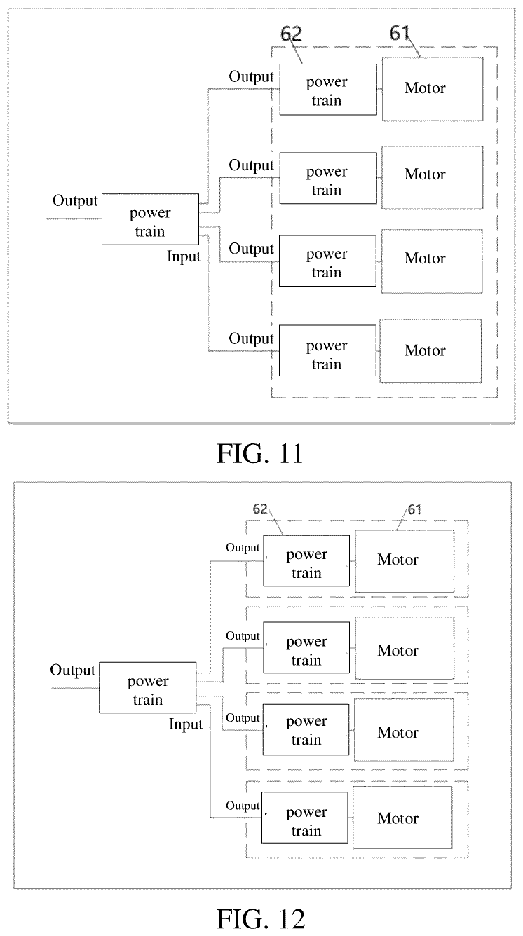

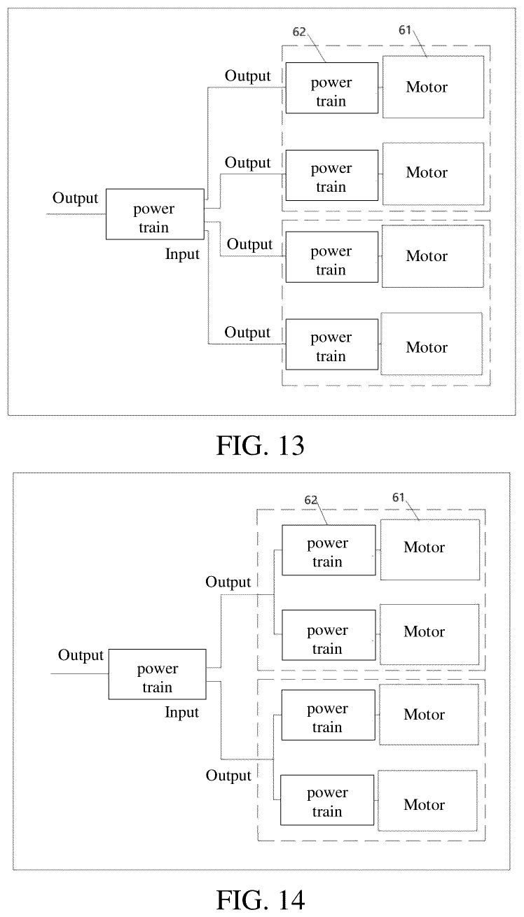

Referring to FIG. 9 to FIG. 13 and FIG. 4, certainly, a plurality of power train units 62 may further be arranged. The plurality of power train units 62 are coupled to a plurality of power units 61 in a one-to-one correspondence, so that one power train unit 62 can be correspondingly coupled to each of the power units 61 to realize targeted speed adjustment of the power unit 61. Output ends of the power train units 62 are coupled to an input end of the plunger pump 1.

Referring to FIG. 1 to FIG. 4, in the present disclosure, the electrically-driven fracturing apparatus further includes a high-pressure manifold assembly 4 and a low-pressure manifold assembly 5. The high-pressure manifold assembly 4 and the low-pressure manifold assembly 5 are both coupled to the plunger pump 1. The low-pressure manifold assembly 5 is configured to implement liquid feeding, and the high-pressure manifold assembly 4 is configured to implement discharging.

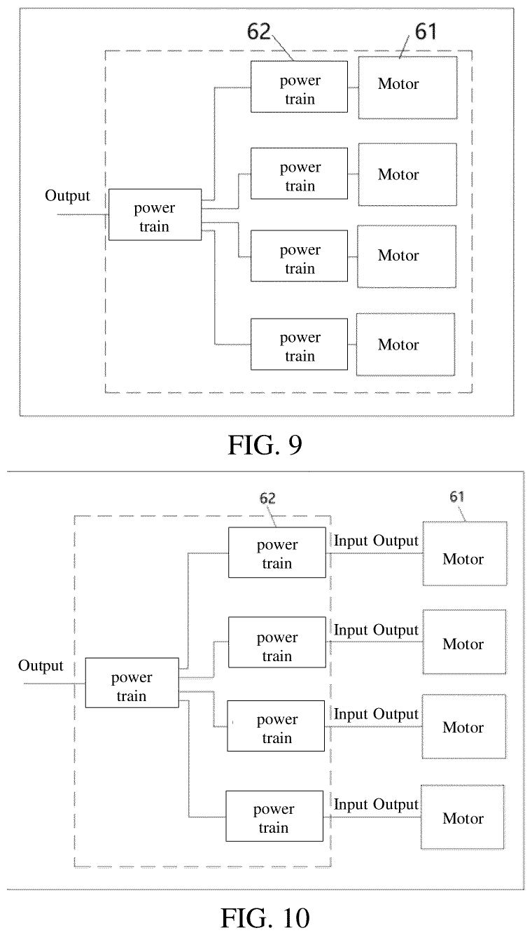

Referring to FIG. 9 to FIG. 13, the power train unit 62 further includes a main power train unit and an auxiliary power train unit that are coupled together, at least two auxiliary power train units are provided, the auxiliary power train units are coupled to the power units 61 in a one-to-one correspondence, an input end of the main power train unit is coupled to output ends of the auxiliary power train units, and an output end of the main power train unit is coupled to the plunger pump 1. The output ends of the auxiliary power train units are collectively coupled through the main power train unit, thereby outputting a reduced rotational speed, outputting an unadjusted rotational speed, or outputting an increased rotational speed. For ease of understanding, in the accompanying drawings of the present disclosure, an example in which four motors are arranged is used, so that a specific coupling mode of each of the motors is shown in detail.

Referring to FIG. 7 to FIG. 15, the power module 6 is provided as a one-piece structure, or the power train unit 62 is provided as a one-piece structure, or the power units 61 and the auxiliary power train units are provided as a one-piece structure, or an auxiliary power train unit and a power unit 61 coupled to the auxiliary power train unit are provided as a one-piece structure, or any set of auxiliary power train units and power units 61 that are coupled together are provided as a one-piece structure.

Referring to FIG. 7 to FIG. 13, any quantity of auxiliary power train units and any quantity of power units 61 that are coupled together are provided as a one-piece structure to form a sub-power module 6, an output end of the sub-power module 6 is formed by coupling together the auxiliary power train units in the sub-power module, and the output end of the sub-power module 6 is coupled to the input end of the main power train unit.

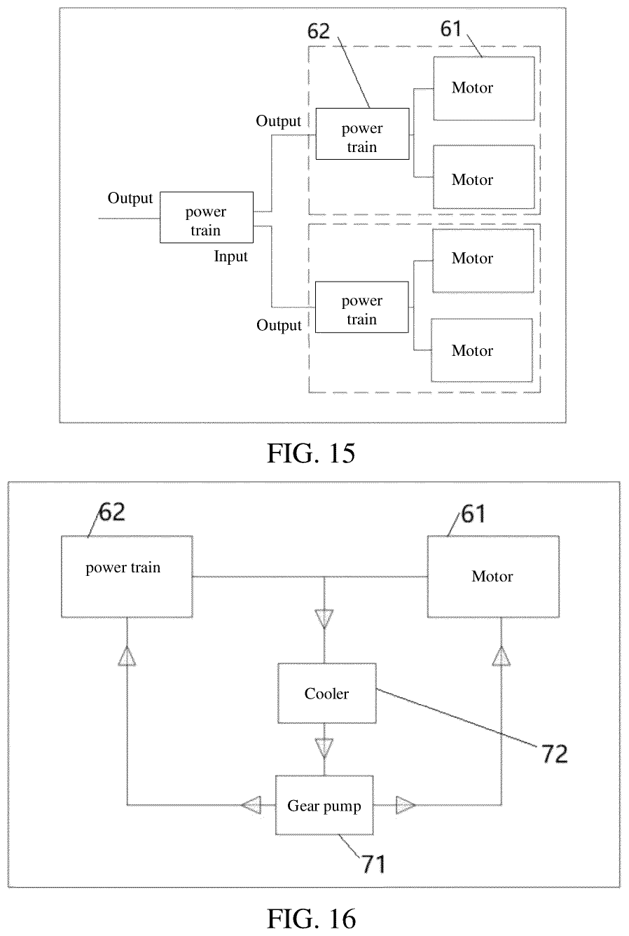

Referring to FIG. 14 and FIG. 15, the power train unit 62 further includes a main power train unit and an auxiliary power train unit that are coupled together, at least two power units 61 are coupled to an input end of the auxiliary power train unit, and an output end of the auxiliary power train unit is coupled to the main power train unit.

Referring to FIG. 1 to FIG. 3, the electrically-driven fracturing apparatus provided in the embodiments of the present disclosure further includes a cooling system 7. The cooling system 7 is configured to cool the power module 6. The cooling system 7 includes an air-cooling system or a water-cooling system.

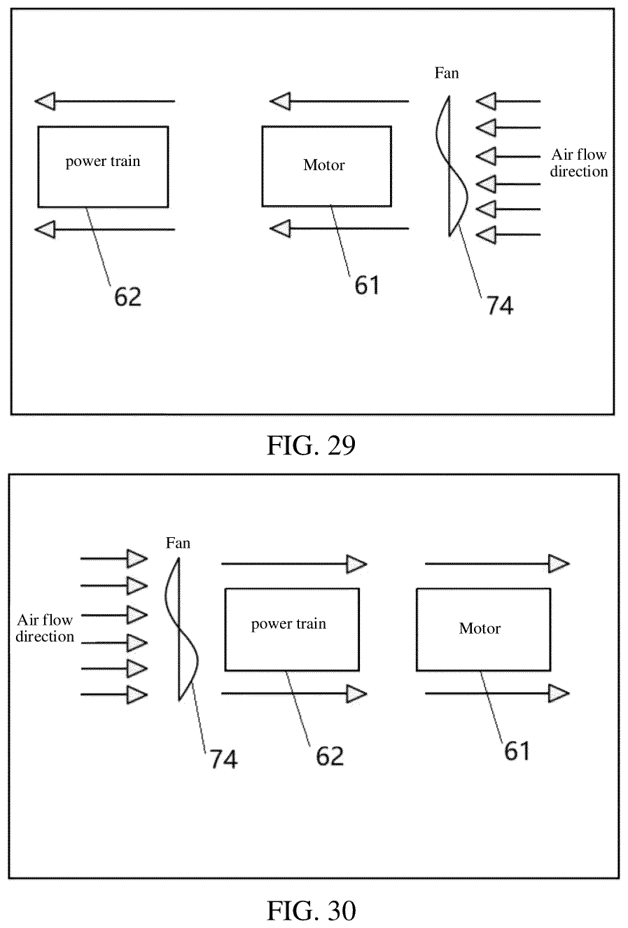

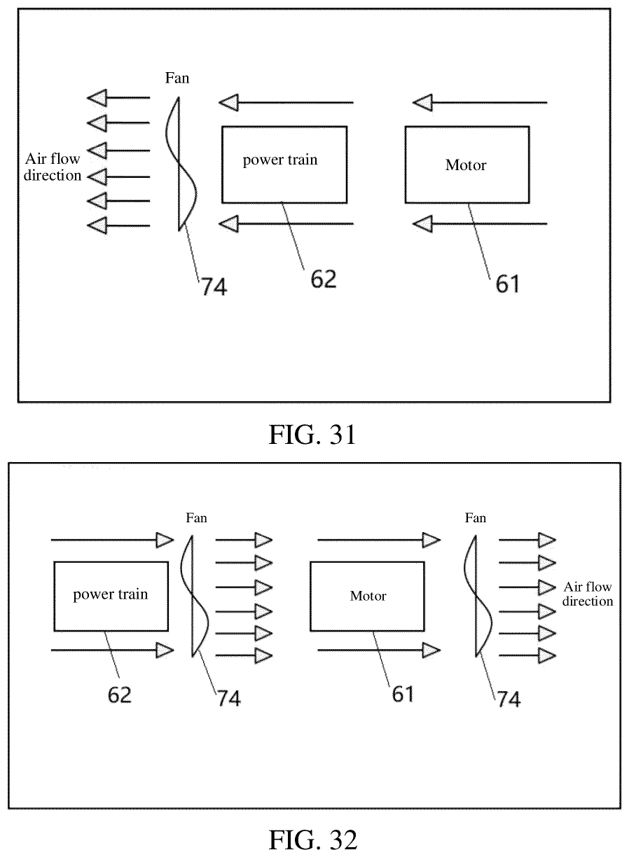

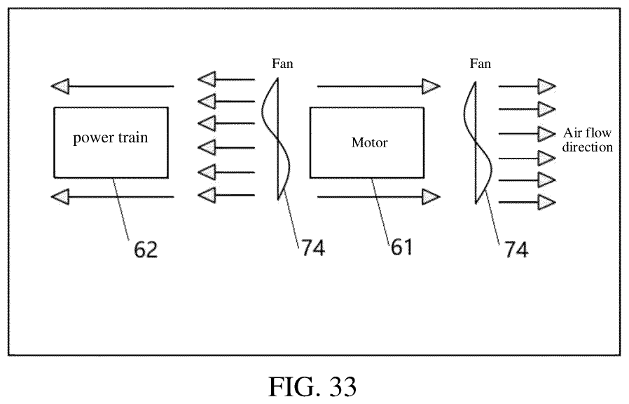

With reference to FIG. 28 to FIG. 33, the air-cooling system includes a fan 74. The fan rotates to drive flow of air, thereby dissipating heat of a motor and a transmission. Exemplarily, one fan 74 may be arranged. The motor and the transmission both achieve a cooling effect through the fan 74. The motor and the transmission are arranged in sequence in a blowing direction of the fan 74, or the transmission and the motor are arranged in sequence in the blowing direction of the fan 74. In this way, air blown out by the fan 74 may pass through the motor and the transmission, thereby cooling the motor and the transmission for heat dissipation. Certainly, at least two fans 74 may further be arranged. At least one fan 74 is arranged corresponding to the motor, so that air blown out by the fan 74 may cool the motor. At least one fan 74 corresponds to the transmission, so that air blown out by the fan 74 may cool the transmission to ensure the cooling effect.

However, when the air-cooling system is used to cool the power module 6, to ensure that the air flow can dissipate internal heat of the motor, a relatively large air volume is required at this time. However, the motor cannot achieve a very high level of protection, and during cooling, moisture, dust, and the like can easily enter an interior of the motor, leading to a decrease in insulation resistance of the motor and causing an apparatus to fail to operate normally. Therefore, in the electrically-driven fracturing apparatus provided in the present disclosure, the water-cooling system is used as the cooling system 7.

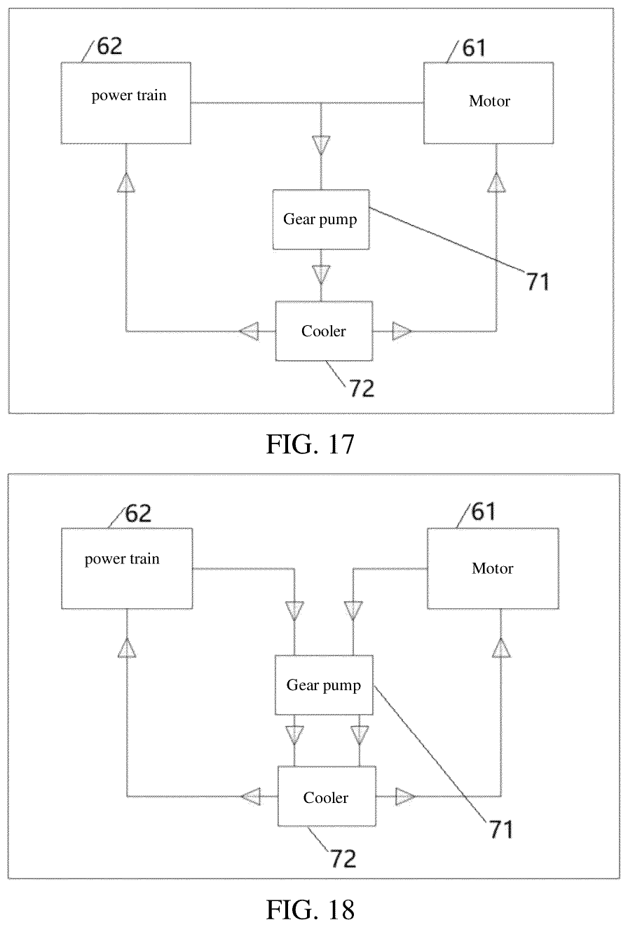

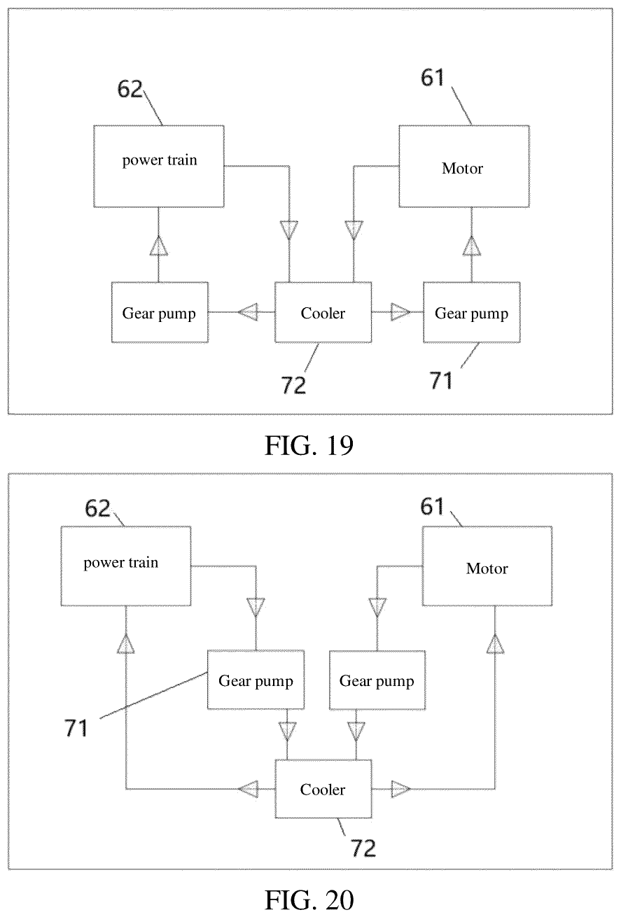

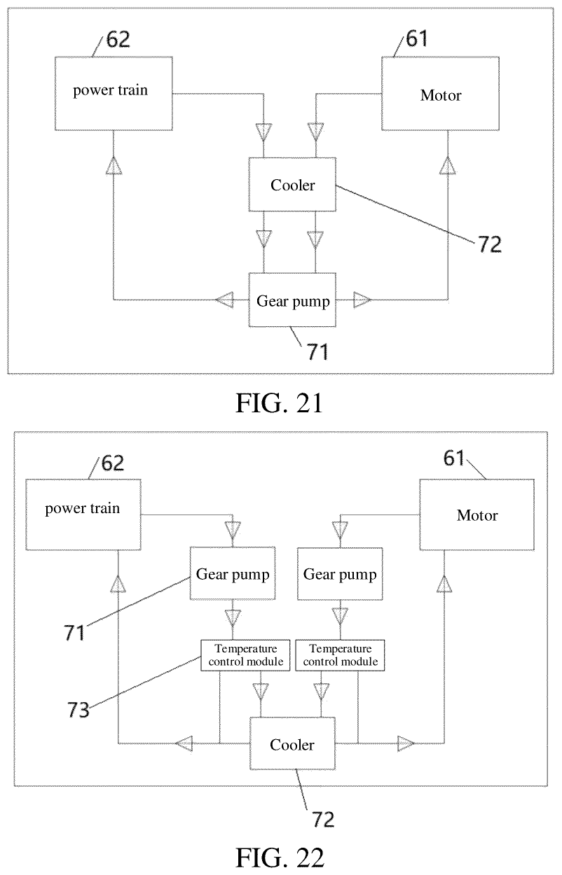

With reference to FIG. 16 to FIG. 21, the cooling system 7 includes a cooling medium and a power drive unit 71. A cooling channel for circulation of the cooling medium is formed in each of the power units 61 and the power train unit 62. The power drive unit 71 is configured to drive the cooling medium to circulate, and the cooling channels are in contact with outside air to perform heat exchange on the cooling medium through the outside air. The cooling medium may be gear oil, clean water, antifreeze, or the like. The power drive unit 71 adopts a gear pump, a centrifugal pump, or the like, and the gear pump, centrifugal pump, or the like may be driven through a motor, a pneumatic pump, a hydraulic pump, or the like. The cooling medium flows through an interior of the motor or the transmission to take away heat inside the motor, resulting in an increase in a temperature of the cooling medium. After flowing out of the interior of the motor or the transmission, the cooling medium may undergo heat exchange with external air. The external air takes away heat of the cooling medium to reduce the temperature of the cooling medium. In a water-cooling manner, the entire motor may be designed as a fully enclosed structure to achieve a high level of protection, so as to completely prevent moisture, dampness, dust, and the like from entering the interior of the motor, and is more adaptable to a harsh operating environment of an oil field.

The cooling system 7 further includes a cooler 72 in communication with the cooling channels, and the cooler 72 is configured to perform heat exchange on the cooling medium. The cooling medium of the motor is connected to the cooler 72 through a water inlet and a water outlet of the motor. After entering the cooler 72, the cooling medium exchanges heat with external air in the cooler 72 to achieve a reduction in the temperature of the cooling medium. The cooled cooling medium enters the interior of the motor again to cool the interior of the motor. Through arrangement of the cooler 72, the cooling medium at a relatively low temperature flows out of the interior of the motor or the transmission and then enters the cooler 72, and flows out of the cooler 72 again and then enters the interior of the motor or the transmission to take away heat inside the motor again, so as to finally ensure that a component such as an internal winding of the motor or a transmission component is kept within a normal temperature range.

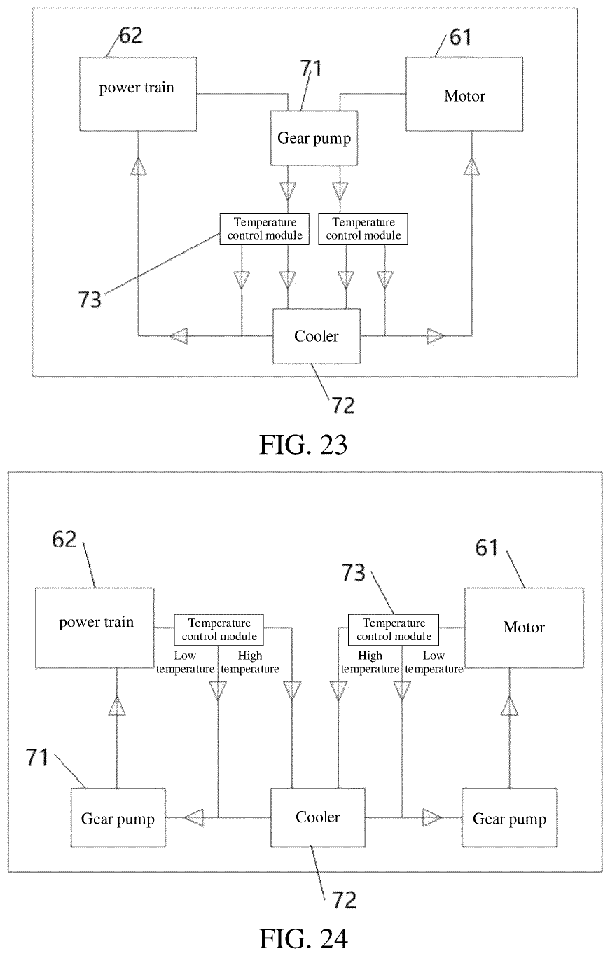

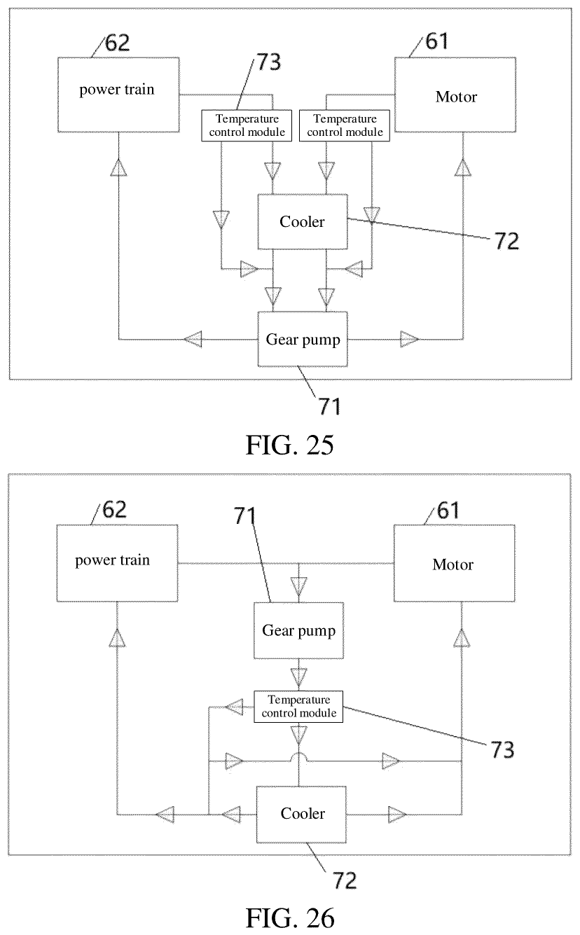

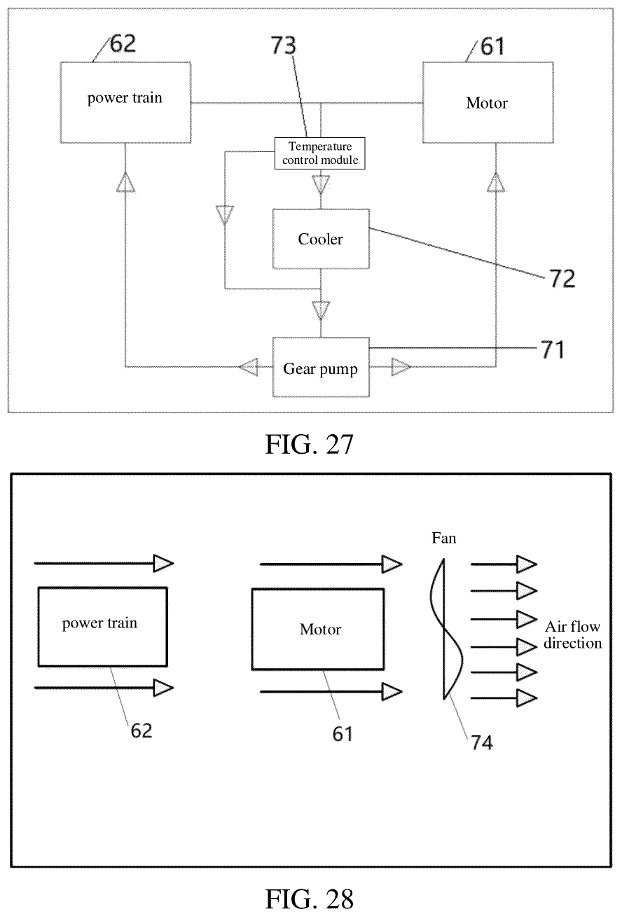

With reference to FIG. 23 to FIG. 27, the cooling system 7 further includes a temperature control module 73. The temperature control module 73 is configured to monitor a temperature of the cooling medium, to selectively bring the cooling channels into communication with the cooler 72. In the embodiments of the present disclosure, a connection relationship between the temperature control module 73 and the cooler 72 is not limited, as long as the cooling medium can be selectively connected to the cooler 72. The temperature control module 73 may automatically determine, based on the temperature of the cooling medium, whether the cooling medium passes through the cooler 72, thereby increasing an energy utilization rate of an apparatus. A fan of the cooler 72 may automatically determine, based on the temperature of the cooling medium, whether to rotate and control a magnitude of a rotation speed.

It should be understood that terms used herein are for the purpose of describing specific example embodiments only, and are not intended to be limiting. The singular forms “a/an”, “one”, and “the” as used herein may also mean including the plural forms, unless the context clearly indicates otherwise. The terms “comprise”, “include”, “contain”, and “have” are inclusive and therefore indicate the presence of the stated features, steps, operations, elements, and/or components, but do not exclude the presence or addition of one or more other features, steps, operations, elements, components, and/or combinations thereof. Method steps, processes, and operations described herein are not to be construed as requiring them to be performed in a specific order described or indicated, unless the order of execution is explicitly specified. It should further be understood that additional or alternative steps may be used.

Although terms “first”, “second”, “third”, and the like may be used herein to describe a plurality of elements, components, regions, layers, and/or sections, these elements, components, regions, and/or sections should not be limited by these terms. These terms may be used only to distinguish one element, component, region, layer, or section from another region, layer, or section. Unless the context explicitly indicates otherwise, the terms such as “first” and “second” and other numerical terms do not imply an order or a sequence when used herein. Therefore, a first element, component, region, layer, or section discussed below may be referred to as a second element, component, region, layer, or section without departing from the teachings of example implementations.

The foregoing descriptions are only specific implementations of the present disclosure, so that a person skilled in the art can understand or implement the present disclosure. Various modifications to these embodiments are apparent to a person skilled in the art, and general principles defined herein may be implemented in other embodiments without departing from the spirit or scope of the present disclosure. Therefore, the present disclosure is not limited to these embodiments described herein, but conforms to the broadest scope consistent with the principles and novel features disclosed herein.

1. An electrically-driven fracturing apparatus, comprising:
a plunger pump;
a lubrication system, comprising a fluid end lubrication system and a power end lubrication system, wherein the fluid end lubrication system is configured to lubricate a fluid end of the plunger pump, and the power end lubrication system is configured to lubricate a power end of the plunger pump; and
a power module, configured to provide power to the plunger pump, wherein the power module comprises a power train unit and at least two power units, output ends of the at least two power units are coupled to an input end of the power train unit, and an output end of the power train unit is coupled to the plunger pump.

2. The electrically-driven fracturing apparatus according to claim 1, wherein the power train unit comprises a main power train unit and at least two auxiliary power train units, the main power train unit is coupled to each of the at least two auxiliary power train units, the auxiliary power train units are coupled to the power units in one-to-one correspondence, an input end of the main power train unit is coupled to output ends of the auxiliary power train units, and an output end of the main power train unit is coupled to the plunger pump.

3. The electrically-driven fracturing apparatus according to claim 2, wherein the power train unit is provided as a one-piece structure.

4. The electrically-driven fracturing apparatus according to claim 2, wherein the auxiliary power train units and the power units that are coupled together and are provided as a one-piece structure to form a sub-power module, an output end of the sub-power module is formed by coupling together the auxiliary power train units in the sub-power module, and the output end of the sub-power module is coupled to the input end of the main power train unit.

5. The electrically-driven fracturing apparatus according to claim 1, wherein the power train unit further comprises a main power train unit and an auxiliary power train unit that are coupled together, the at least two power units are coupled to an input end of the auxiliary power train unit, and an output end of the auxiliary power train unit is coupled to the main power train unit.

6. The electrically-driven fracturing apparatus according to claim 5, wherein the power units and the power train unit are provided as a one-piece structure.

7. The electrically-driven fracturing apparatus according to claim 1, further comprising a cooling system, wherein the cooling system is configured to cool the power module.

8. The electrically-driven fracturing apparatus according to claim 7, wherein the cooling system comprises a cooling medium and a power drive unit, a cooling channel for circulation of the cooling medium is formed in each of the power units and the power train unit, the power drive unit is configured to circulate the cooling medium, and the cooling channel performs heat exchange on the cooling medium through the outside air.

9. The electrically-driven fracturing apparatus according to claim 8, wherein the cooling system further comprises a cooler in communication with the cooling channel, and the cooler is configured to perform heat exchange on the cooling medium.

10. The electrically-driven fracturing apparatus according to claim 9, wherein the cooling system further comprises a temperature control module, and the temperature control module is configured to monitor a temperature of the cooling medium, to selectively bring the cooling channels into communication with the cooler.

11. The electrically-driven fracturing apparatus according to claim 2, wherein the power units and the auxiliary power train units are provided as a one-piece structure.

12. The electrically-driven fracturing apparatus according to claim 2, an auxiliary power train unit and a power unit coupled to the auxiliary power train unit are provided as a one-piece structure.

13. The electrically-driven fracturing apparatus according to claim 2, wherein any set of auxiliary power train units and power units that are coupled together are provided as a one-piece structure.

14. The electrically-driven fracturing apparatus according to claim 5, wherein the power units and the power train unit are provided as separate structures.
